(19) United States
(12) Patent Application Publication
(10) Pub. No.: US 2025/0291831 A1
(43) Pub. Date: Sep. 18, 2025

(54) MULTIMODAL SENSOR AGNOSTIC LOCALIZATION USING ONE OR MORE ADAPTIVE FEATURE GRAPHS

(71) Applicant: QUALCOMM Incorporated, San Diego, CA (US)

(72) Inventors: Deeksha DIXIT, San Diego, CA (US); Varun RAVI KUMAR, San Diego, CA (US); Senthil Kumar YOGAMANI, Headford (IE)

(21) Appl. No.: 18/607,036

(22) Filed: Mar. 15, 2024

(51) Int. Cl. G06F 16/36; G01S 13/89; G01S 15/89; G01S 17/89; G06T 3/02; G06T 7/11; G06V 10/40; G06V 10/77

(52) U.S. Cl. CPC G06F 16/367; G01S 13/89; G01S 15/89; G01S 17/89; G06T 3/02; G06T 7/11; G06V 10/40; G06V 10/7715

(57) ABSTRACT

Techniques and systems are provided for processing image data. For instance, a process can include: obtaining a first set of image features from one or more images of an environment captured by a camera; transforming the first set of image features to generate a first set of bird's eye view (BEV) image features; obtaining a second set of features obtained using a sensor having a different sensor type than the camera; transforming the second set of features to generate a second set of BEV features; normalizing the first set of BEV image features based on camera configuration information associated with the one or more images; normalizing the second set of BEV features based on sensor configuration information of the sensor; and generating a query graph based on the normalized first set of BEV image features and the normalized second set of BEV features.

### FIELD

The present application is related to processing sensor data. For example, aspects of the present application relate to systems and techniques for multimodal sensor agnostic localization using one or more adaptive feature graphs (e.g., birds eye view (BEV) feature graph(s)).

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, environment modelling/rendering, etc. One example of such a system is a localization system for XR devices and/or Advanced Driver Assistance System (ADAS) for a vehicle. In such systems, sensor data, such as images captured from one or more cameras, may be gathered, transformed, and analyzed to detect features and/or objects (e.g., targets). Detected features may be compared to features indicated on a map to determine where the device and/or vehicle is located. However, such systems may rely on perspective views of the environment and thus may be sensitive to sensor placement, occlusions, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems and techniques for processing image data are provided. In one illustrative example, an apparatus for processing image data is provided. The apparatus includes at least one memory and at least one processor coupled to the at least one memory. The at least one processor is configured to: obtain a first set of image features from one or more images of an environment captured by a camera; transform the first set of image features to generate a first set of bird's eye view (BEV) image features; obtain a second set of features, the second set of features generated based on a representation of the environment obtained using a sensor having a different sensor type than the camera; transform the second set of features to generate a second set of BEV features; normalize the first set of BEV image features based on camera configuration information associated with the one or more images; normalize the second set of BEV features based on sensor configuration information of the sensor; and generate a query graph based on the normalized first set of BEV image features and the normalized second set of BEV features.

As another example, a method for processing image data is provided. The method includes: obtaining a first set of image features from one or more images of an environment captured by a camera; transforming the first set of image features to generate a first set of bird's eye view (BEV) image features; obtaining a second set of features, the second set of features generated based on a representation of the environment obtained using a sensor having a different sensor type than the camera; transforming the second set of features to generate a second set of BEV features; normalizing the first set of BEV image features based on camera configuration information associated with the one or more images; normalizing the second set of BEV features based on sensor configuration information of the sensor; and generating a query graph based on the normalized first set of BEV image features and the normalized second set of BEV features.

In another example, a non-transitory computer-readable medium having stored thereon instructions that, when executed by at least one processor, cause the at least one processor to: obtain a first set of image features from one or more images of an environment captured by a camera; transform the first set of image features to generate a first set of bird's eye view (BEV) image features; obtain a second set of features, the second set of features generated based on a representation of the environment obtained using a sensor having a different sensor type than the camera; transform the second set of features to generate a second set of BEV features; normalize the first set of BEV image features based on camera configuration information associated with the one or more images; normalize the second set of BEV features based on sensor configuration information of the sensor; and generate a query graph based on the normalized first set of BEV image features and the normalized second set of BEV features.

As another example, an apparatus for processing image data. The apparatus includes: means for obtaining a first set of image features from one or more images of an environment captured by a camera; means for transforming the first set of image features to generate a first set of bird's eye view (BEV) image features; means for obtaining a second set of features, the second set of features generated based on a representation of the environment obtained using a sensor having a different sensor type than the camera; means for transforming the second set of features to generate a second set of BEV features; normalizing the first set of BEV image features based on camera configuration information associated with the one or more images; means for normalizing the second set of BEV features based on sensor configuration information of the sensor; and means for generating a query graph based on the normalized first set of BEV image features and the normalized second set of BEV features.

In some aspects, one or more of the apparatuses described herein can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the apparatus(es) can include at least one camera for capturing one or more images or video frames. For example, the apparatus(es) can include a camera (e.g., an RGB camera) or multiple cameras for capturing one or more images and/or one or more videos including video frames. In some aspects, the apparatus(es) can include a display or multiple displays for displaying one or more images, videos, notifications, or other displayable data. In some aspects, the apparatus(es) can include one or more transmitters, one or more receivers, or one or more transceivers configured to transmit and/or receive data or information over a transmission medium to/from at least one device. In some aspects, the apparatus(es) can include a processor or multiple processors, which may include a central processing unit (CPU), a graphics processing unit (GPU), a neural processing unit (NPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure;

FIG. 2 is a diagram illustrating an architecture of an example extended reality (XR) system, in accordance with some aspects of the disclosure;

FIG. 3A is a diagram illustrating an example of a fully-connected neural network, in accordance with some examples of the present disclosure;

FIG. 3B is a diagram illustrating an example of a locally-connected neural network, in accordance with some examples of the present disclosure;

FIG. 3C is a diagram illustrating an example of a convolutional neural network, in accordance with some examples of the present disclosure;

FIG. 3D is a diagram illustrating an example of a deep convolutional network (DCN) for recognizing visual features from an image, in accordance with some examples of the present disclosure;

FIG. 4 is a block diagram illustrating an example deep convolutional network (DCN), in accordance with some examples of the present disclosure;

FIG. 5 illustrates a technique for generating multimodal BEV feature maps, in accordance with aspects of the present disclosure;

FIG. 6 is a block diagram illustrating a technique for multimodal localization using a BEV feature graph, in accordance with aspects of the present disclosure;

FIG. 7 is a flow diagram illustrating a process for mapping, in accordance with aspects of the present disclosure; and

FIG. 8 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

In some cases, a device may have one or more sensors (e.g., image sensors, such as a camera, range sensors such as radar and/or light detection and ranging (LIDAR) sensors, sonar sensors, etc.). The device can include an extended reality (XR) device (e.g., a virtual reality (VR) device, an augmented reality (AR) device, and/or a mixed reality (MR) device), a vehicle (e.g., automated vehicles, semi-automated vehicles, autonomous vehicles, etc.), a robotic device (e.g., an automated vacuum cleaner, an industrial robotic device, etc.), or other type of device. The one or more sensors may be used to obtain information about an environment in which the device is located. A processing system of the device may be used to process the information for one or more operations, such as mapping, localization, route planning, navigation, collision avoidance, among others. For example, in some cases, the sensor data may be obtained from the one or more sensor (e.g., one or more images captured from one or more cameras, depth information captured or determined by one or more radar and/or LIDAR sensors, etc.), transformed, and analyzed to determine where in the environment the device is located.

Localization may be used to determine a precise position of a device on a map. Localization may be performed based on data input from sensors and a map. For example, a device may obtain information about the environment using one or more sensors. The device may compare the information about the environment to a map of the environment to locate the device. In some cases, the device may build a map of the environment using the information about the environment obtained from the one or more sensors. In some cases, simultaneous localization and mapping (SLAM) techniques may be used for localization and mapping. Existing SLAM techniques tend to rely on perspective views, which can be sensitive sensor locations, and may use multi-layer maps which different layers corresponding to different types of sensors, which can be difficult to generalize. Techniques to enhance localization may be useful.

Systems, apparatuses, electronic devices, methods (also referred to as processes), and computer-readable media (collectively referred to herein as “systems and techniques”) are described herein for a multimodal sensor agnostic localization using an adaptive feature graph. The feature graph may be a bird's eye view (BEV) feature graph. For example, SLAM may be enhanced by performing SLAM in a multimodal normalized BEV feature space using graph representations. In some cases, a set of image features may be obtained based on captured images. Another set of features may be obtained based on a representation of the environment obtained by another sensor having a different sensor type. This other sensor may be a radar sensor, LIDAR sensor, sonar sensor, etc. The set of image features and the other set of features may be projected into a BEV feature space (e.g., feature map).

The set of image features, in the BEV feature space, may be normalized based on camera configuration information. Similarly, the other set of features may be normalized based on sensor configuration associated with the other sensor. In some cases, the camera configuration information may be based on calibration information associated with the camera including information about a field of view (FOV) of the camera, principal point of the camera, lens distortion information, etc. In some cases, the sensor configuration information may include information about a mounting height, tilt angle, FOV, or range of the sensor. In some cases, the camera configuration information and/or sensor configuration information may be dynamically refined over time or based on estimates of the environment. For example, normalization of a FOV of the camera may be adapted based on a range of an object, which may vary over time. In some cases, the configuration information for normalization may be predicted using a machine learning model. In some cases, data obtained by one sensor may be used to determine the configuration for normalization for another sensor.

The normalized BEV feature space may then be transformed into a graph by dividing up the BEV feature space into a grid of cells. Each cell may be mapped into a node of a graph and features in each cell may be aggregated into the corresponding node to generate a query graph. The query graph may be compared to a scene graph to determine where the device is located by identifying a portion of the scene graph that most closely matches with the query graph. In some cases, the comparison may be based on feature descriptors of the query graph and the scene graph. In some cases, a feature descriptor of the query graph may be generated by a graph neural network.

Various aspects of the application will be described with respect to the figures.

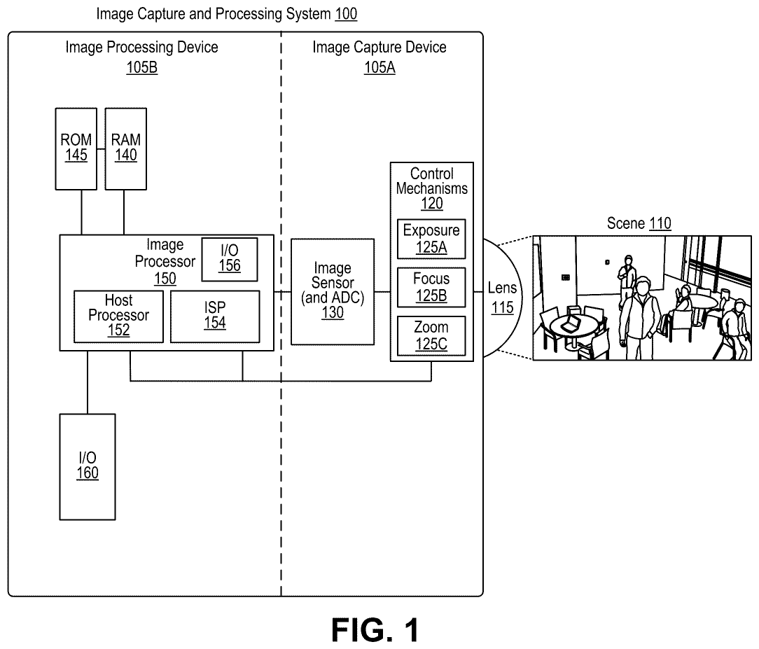

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

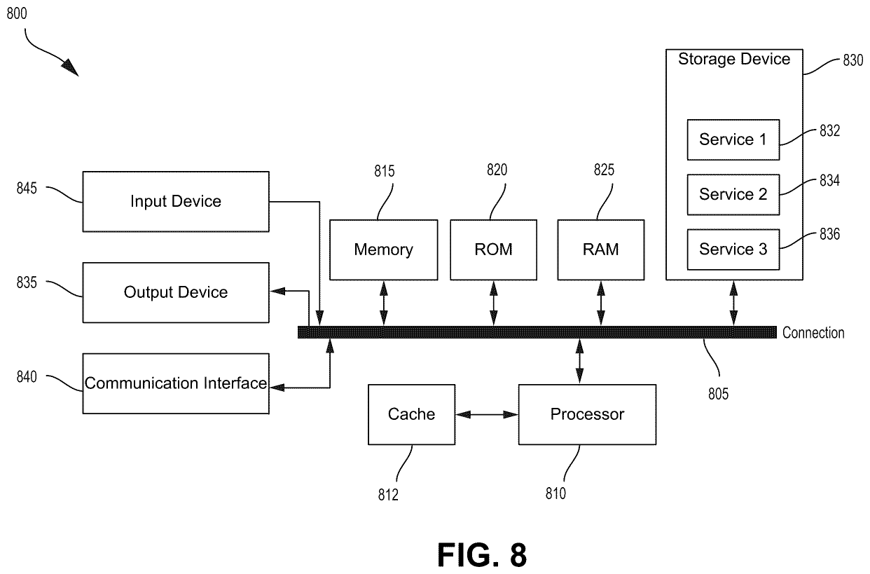

The image processor 150 may include one or more processors, such as one or more image signal processors (ISPs) (including ISP 154), one or more host processors (including host processor 152), and/or one or more of any other type of processor 1010 discussed with respect to the computing system 800 of FIG. 8. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

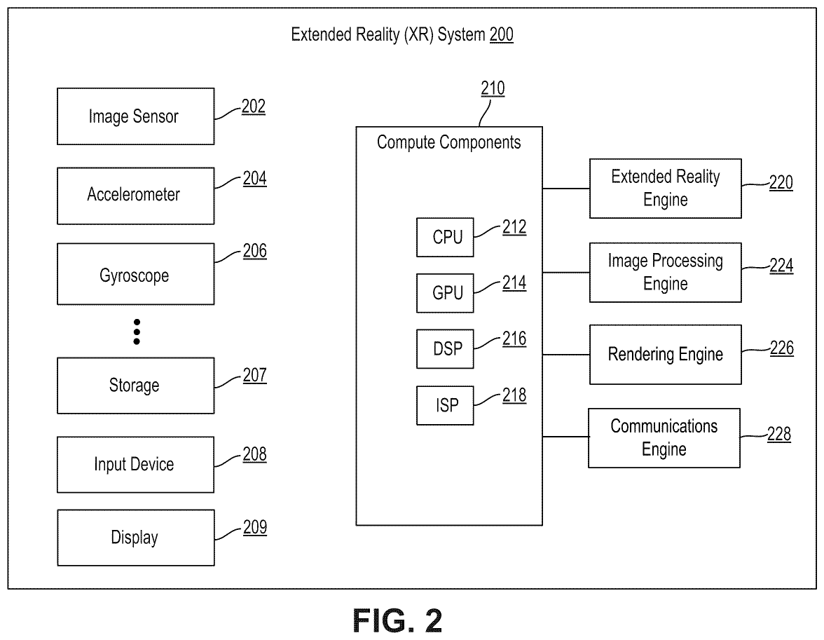

In some examples, the extended reality (XR) system 200 of FIG. 2 can include the image capture and processing system 100, the image capture device 105A, the image processing device 105B, or a combination thereof.

FIG. 2 is a diagram illustrating an architecture of an example extended reality (XR) system 200, in accordance with some aspects of the disclosure. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the XR system 200 can include one or more other sensors (e.g., one or more inertial measurement units (IMUs), RADARs, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1045 discussed herein, or any combination thereof. In some cases, the image sensor 202 can capture images that can be processed for interpreting gesture commands.

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 840 of FIG. 8.

In some implementations, the one or more image sensors 202, the accelerometer 204, the gyroscope 206, storage 207, compute components 210, XR engine 220, image processing engine 224, and rendering engine 226 can be part of the same computing device. For example, in some cases, the one or more image sensors 202, the accelerometer 204, the gyroscope 206, storage 207, compute components 210, XR engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or simultaneous localization and mapping (SLAM) techniques. For instance, the compute components 210 can perform SLAM or can be in communication (wired or wireless) with a SLAM system. SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 210 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

In some cases, sensor data, such as images captured by the image capture and processing system 100, point clouds captured by LIDAR/RADAR sensors, etc., may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

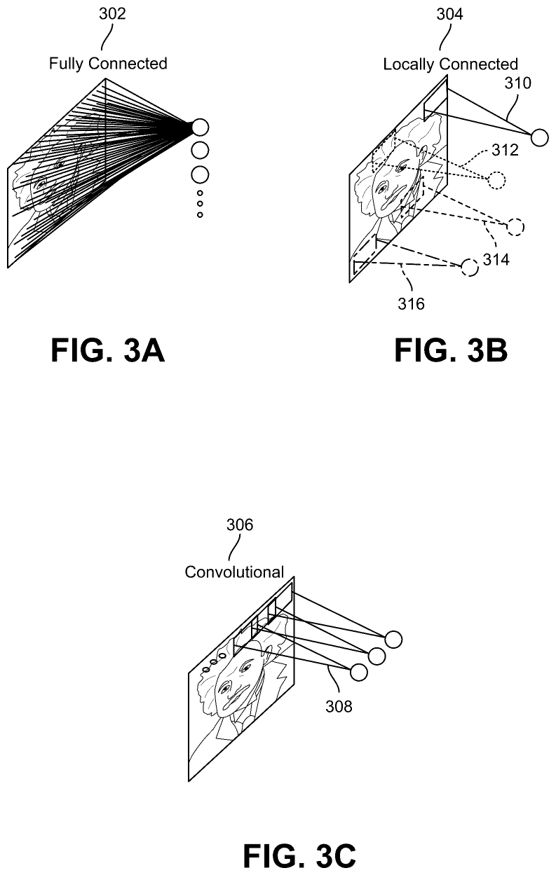

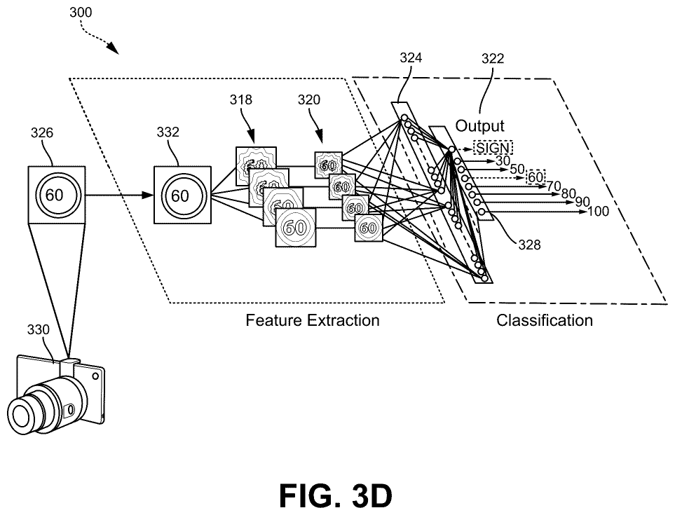

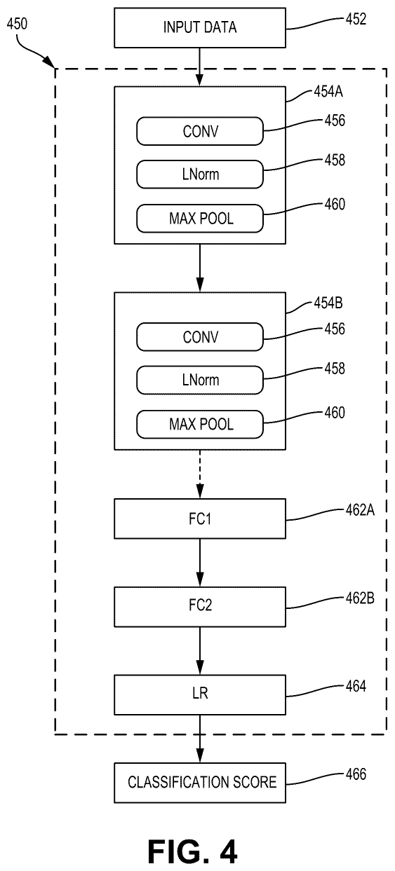

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 3A-FIG. 4.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 3A illustrates an example of a fully connected neural network 302. In a fully connected neural network 302, a neuron in a first layer may communicate its output to every neuron in a second layer, so that each neuron in the second layer will receive input from every neuron in the first layer. FIG. 3B illustrates an example of a locally connected neural network 304. In a locally connected neural network 304, a neuron in a first layer may be connected to a limited number of neurons in the second layer. More generally, a locally connected layer of the locally connected neural network 304 may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 3C illustrates an example of a convolutional neural network 306. The convolutional neural network 306 may be configured such that the connection strengths associated with the inputs for each neuron in the second layer are shared (e.g., 308). Convolutional neural networks may be well suited to problems in which the spatial location of inputs is meaningful. Convolutional neural network 306 may be used to perform one or more aspects of video compression and/or decompression, according to aspects of the present disclosure.

One type of convolutional neural network is a deep convolutional network (DCN). FIG. 3D illustrates a detailed example of a DCN 300 designed to recognize visual features from an image 326 input from an image capturing device 330, such as an image capture and processing system 100 of FIG. 1. The DCN 300 of the current example may be trained to identify traffic signs and a number provided on the traffic sign. Of course, the DCN 300 may be trained for other tasks, such as identifying lane markings or identifying traffic lights.

The DCN 300 may be trained with supervised learning. During training, the DCN 300 may be presented with an image, such as the image 326 of a speed limit sign, and a forward pass may then be computed to produce an output 322. The DCN 300 may include a feature extraction section and a classification section. Upon receiving the image 326, a convolutional layer 332 may apply convolutional kernels (not shown) to the image 326 to generate a first set of feature maps 318. As an example, the convolutional kernel for the convolutional layer 332 may be a 5×5 kernel that generates 28×28 feature maps. In the present example, because four different feature maps are generated in the first set of feature maps 318, four different convolutional kernels were applied to the image 326 at the convolutional layer 332. The convolutional kernels may also be referred to as filters or convolutional filters.

The first set of feature maps 318 may be subsampled by a max pooling layer (not shown) to generate a second set of feature maps 320. The max pooling layer reduces the size of the first set of feature maps 318. That is, a size of the second set of feature maps 320, such as 14×14, is less than the size of the first set of feature maps 318, such as 28×28. The reduced size provides similar information to a subsequent layer while reducing memory consumption. The second set of feature maps 320 may be further convolved via one or more subsequent convolutional layers (not shown) to generate one or more subsequent sets of feature maps (not shown).

In the example of FIG. 3D, the second set of feature maps 320 is convolved to generate a first feature vector 324. Furthermore, the first feature vector 324 is further convolved to generate a second feature vector 328. Each feature of the second feature vector 328 may include a number that corresponds to a possible feature of the image 326, such as “sign,” “60,” and “100.” A softmax function (not shown) may convert the numbers in the second feature vector 328 to a probability. As such, an output 322 of the DCN 300 is a probability of the image 326 including one or more features.

In the present example, the probabilities in the output 322 for “sign” and “60” are higher than the probabilities of the others of the output 322, such as “30,” “40,” “50,” “70,” “80,” “90,” and “100”. Before training, the output 322 produced by the DCN 300 is likely to be incorrect. Thus, an error may be calculated between the output 322 and a target output. The target output is the ground truth of the image 326 (e.g., “sign” and “60”). The weights of the DCN 300 may then be adjusted so the output 322 of the DCN 300 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 322 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 320) receiving input from a range of neurons in the previous layer (e.g., feature maps 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 4 is a block diagram illustrating an example of a deep convolutional network 450. The deep convolutional network 450 may include multiple different types of layers based on connectivity and weight sharing. As shown in FIG. 4, the deep convolutional network 450 includes the convolution blocks 454A, 454B. Each of the convolution blocks 454A, 454B may be configured with a convolution layer (CONV) 456, a normalization layer (LNorm) 458, and a max pooling layer (MAX POOL) 460. Of note, the layers illustrated with respect to convolution blocks 454A and 454B are examples of layers that may be included in a convolution layer and are not intended to be limiting and other types of layers may be included in any order.

The convolution layers 456 may include one or more convolutional filters, which may be applied to the input data 452 to generate a feature map. Although only two convolution blocks 454A, 454B are shown, the present disclosure is not so limiting, and instead, any number of convolution blocks (e.g., convolution blocks 454A, 454B) may be included in the deep convolutional network 450 according to design preference. The normalization layer 458 may normalize the output of the convolution filters. For example, the normalization layer 458 may provide whitening or lateral inhibition. The max pooling layer 460 may provide down sampling aggregation over space for local invariance and dimensionality reduction.

The parallel filter banks, for example, of a deep convolutional network may be loaded on a processor such as a CPU or GPU, or any other type of processor 810 discussed with respect to the computing system 800 of FIG. 8 to achieve high performance and low power consumption. In alternative aspects, the parallel filter banks may be loaded on a DSP or an ISP of the computing system 800 of FIG. 8. In addition, the deep convolutional network 450 may access other processing blocks that may be present on the computing system 800 of FIG. 8, such as sensor processor and navigation module, dedicated, respectively, to sensors and navigation.

The deep convolutional network 450 may also include one or more fully connected layers, such as layer 462A (labeled “FC1”) and layer 462B (labeled “FC2”). The deep convolutional network 450 may further include a logistic regression (LR) layer 464. Between each layer 456, 458, 460, 462A, 462B, 464 of the deep convolutional network 450 are weights (not shown) that are to be updated. The output of each of the layers (e.g., 456, 458, 460, 462A, 462B, 464) may serve as an input of a succeeding one of the layers (e.g., 456, 458, 460, 462A, 462B, 464) in the deep convolutional network 450 to learn hierarchical feature representations from input data 452 (e.g., images, audio, video, sensor data and/or other input data) supplied at the first of the convolution blocks 454A. The output of the deep convolutional network 450 is a classification score 466 for the input data 452. The classification score 466 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 450 may output probabilities that an input data, such as an image, includes certain features. The deep convolutional network 450 may then be modified to extract (e.g., output) certain features. Additionally, DCNs may be added to extract other features as well. This set of DCNs may function as feature extractors to identify features in an image. In some cases, feature extractors may be used as a backbone for additional ML network components to perform further operations, such as localization, image segmentation, object detection, etc.

As indicated above, SLAM may be used to determine a location and/or pose of a device. In some cases, traditional SLAM systems may operate on perspective view images, potentially making them sensitive to a placement of the imaging sensors and sensitive to occlusions, which may degrade performance. Additionally, traditional SLAM systems may be camera based and this reliance on a specific sensor can be limiting.

To help enhance SLAM, it may be useful to allow a SLAM system to utilize a graph representation of meta-features of a bird's eye view (BEV) (e.g., a top-down view) multimodal feature map of an environment. Multimodal features may be generated based on data from multiple different types of sensors, such as an image sensor along with at least one other type of sensor, such as a LIDAR, RADAR, SODAR, SONAR, etc. sensor. Using different sensor types helps provide a more holistic understanding of the environment, increases robustness against failure and/or noise from a single sensor modality, and may help overcome occlusions. In some cases, a sensor type of a sensor may be based on how the sensor senses the environment. For example, two sensors which sense different parts of the electromagnetic spectrum may have different sensor types. Similarly, a sensor which senses reflection/refraction of projected light may have a different sensor type from another sensor which senses natural reflected/refracted light. The multimodal features may be transformed into BEV features to help provide a viewpoint invariant representation that encodes semantic information about the environment. Additionally, the BEV features may be normalized based on sensor configuration to help enable generalizability of the multimodal BEV features across systems with different sensors. Meta-features may refer to features of features (e.g., such as features of the features generated from sensor data). For example, as described in detail below, the BEV multimodal features may be used to generate a graph and meta-features may be features of the graph.

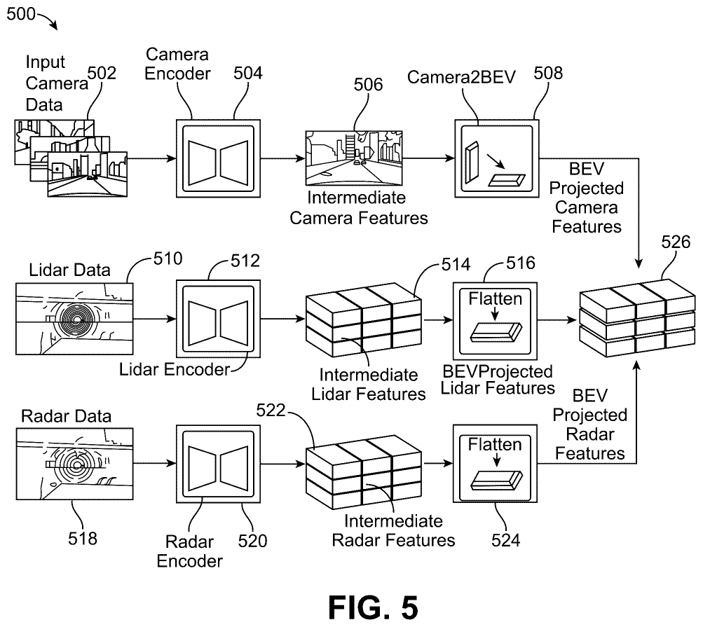

In some cases, sensor data from multiple sensors may be fused to generate multimodal BEV feature maps. FIG. 5 illustrates a technique 500 for generating multimodal BEV feature maps, in accordance with aspects of the present disclosure. In technique 500, input camera data 502 (e.g., images captured by cameras) may be input to a camera data encoder 504. The camera data encoder 504 may include one or feature extractors. These feature extractors may be ML based and be used to identify certain features in the camera data. As an example, the feature extractors may include one or more layers or transformer blocks which may include feature maps for recognizing certain features. The camera data encoder 504 may output the identified features as intermediate camera features 506. Of note, the input camera data 502 and camera data encoder 504 may operate in a 2D space (e.g., on a height and width axes with respect to the camera). A perspective transformation 508 may be applied to the output intermediate camera features which converts the intermediate camera features from, for example a frontal view of an environment from a vehicle, to BEV projected camera features as if features were generated based on a camera positioned above the vehicle. In some cases, the perspective transformation 508 may be ML based.

In some cases, LIDAR data 510 may be received, for example as a LIDAR point cloud, captured by a LIDAR. Lidar may transmit a beam of ultraviolet, visible, or near infrared light into an environment and detects reflections of the beam from objects in the environment. Based on an amount of time needed for the reflections to be detected, distances to objects in the environment may be determined and LIDAR points may be described based on the point's location on a width, height, and depth axes with respect to the LIDAR. Thus, the LIDAR data is three-dimensional data. The LIDAR data 510 may be input to a LIDAR data encoder 512. The LIDAR data encoder 512 may be similar to the camera data encoder 504, but configured (e.g., trained) to operate in a 3D space to identify features in the LIDAR data and output the identified features as intermediate LIDAR features 514. The intermediate LIDAR features 514 may then be flattened 516 to BEV projected LIDAR features, for example, by removing or averaging the height information (e.g., height axes, height channel, height dimension).

In some cases, input RADAR data 518 may be received, for example, as a RADAR point cloud, captured by a RADAR. In some cases, RADAR operates in a manner similar to LIDAR, but uses radio frequency waves rather than light. The input RADAR data 518 may be input to a RADAR data encoder 520. The RADAR data encoder 520 may be similar to the LIDAR data encoder 512 and the RADAR data encoder 520 may identify features in the RADAR data and output the identified features as intermediate RADAR features 522. The intermediate RADAR features 522 may then be flattened 524 to BEV projected RADAR features, for example, by removing or averaging the height information (e.g., height axes, height channel, height dimension).

The BEV projected camera features, BEV projected LIDAR features, and BEV projected RADAR features may be combined into a set of multimodal BEV feature maps 526, for example, by combining the BEV projected camera features, the BEV projected LIDAR features, and the BEV projected RADAR features. In some cases, the BEV projected features may be combined by concatenating the BEV projected camera features, the BEV projected LIDAR features, and the BEV projected RADAR features.

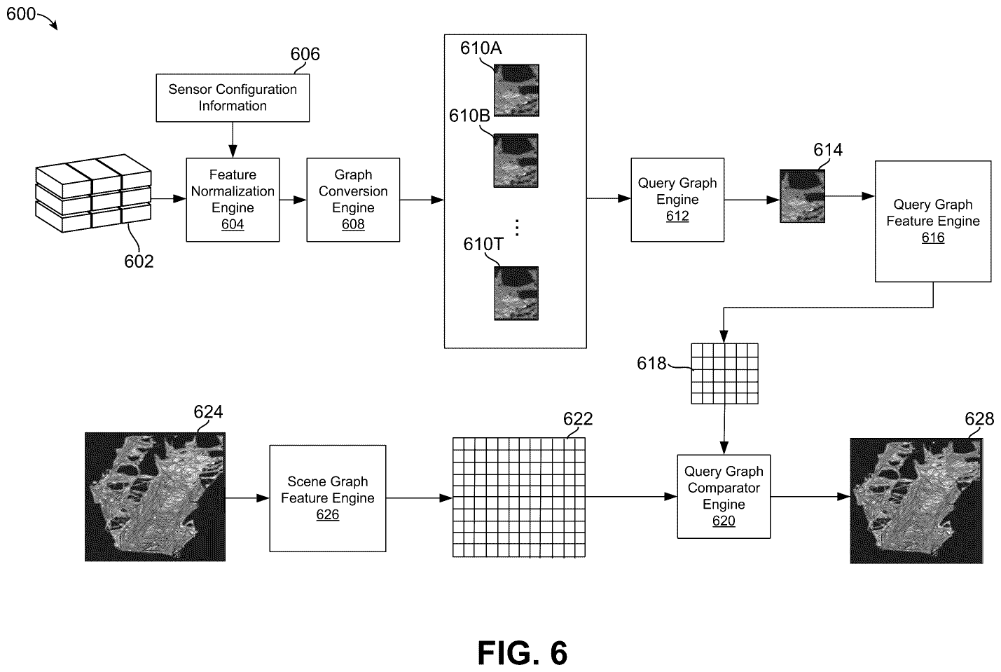

FIG. 6 is a block diagram illustrating a technique 600 for multimodal localization using a BEV feature graph, in accordance with aspects of the present disclosure. In some cases, the technique 600 may operate in a multimodal BEV feature space. In FIG. 6, multimodal BEV feature maps 602 may be received and input to a feature normalization engine 604. The multimodal BEV feature maps 602 may be the multimodal BEV feature maps 526 of FIG. 6.

The feature normalization engine 604 may normalize features of the multimodal BEV feature maps 602 based on a sensor configuration of the sensors used to obtain the features of the multimodal BEV feature maps 602. For example, the multimodal BEV feature maps 602 may include an indication of which sensor (e.g., sensor type) was used to obtain which information, along with configuration information for the sensor (e.g., sensor configuration information 606).

In some cases, the multimodal BEV feature maps may be normalized based on calibration data for the sensors. As an example, configuration information for an image sensor may include calibration data such as camera field of view (FOV), principal point, lens distortion information, etc. In some cases, camera features may be normalized, for example, by dividing pixel intensities by the camera FOV to normalize for field of view, subtracting principal point offset to normalize for camera position, applying an image undistortion transform to normalize for lens distortion, etc. For example, where the image sensor configuration includes a FOV, mounting height (h), tilt angle α, etc., a normalization function (Xₙₒᵣₘ) may be defined that takes the configuration information and feature map X as parameters such that Xₙₒᵣₘ=norm(X, FOV, h, α, . . . ). Where normalization may be performed by dividing feature values by the FOV to normalize for field of view, subtracting h from height values to normalize for mounting height, and applying a rotation transform (e.g., where R(α) represents the rotational transform matrix) based on the tilt angle may be expressed as

$${X}_{n o r m} ( i , j , c ) = \frac{X ( i , j , c )}{FOV} * R ( α ) ,$$

where i, j indexes over the spatial dimensions, and c indexes over the feature channels. A resulting normalized image feature map Xₙₒᵣₘ may be invariant to sensor parameters and may be used to generate a feature graph. As another example, where the configuration information includes a principal point offset (pp), camera intrinsic matrix (K), and horizontal field of view (FOVc), normalizing for camera position, lens distortion and field of view for camera features X_{c}, can be expressed as X_{c}_{ₙₒᵣₘ}=(X_{c}−pp)⊙K⁻¹⊙(FOVc)⁻¹, where ⊙ denotes element-wise operations. The normalized output X_{c}_{ₙₒᵣₘ} may be aligned to a common BEV coordinate system for BEV feature fusion.

As another example, configuration information for a LIDAR sensor may include calibration data such as a mounting height, tilt angle, FOV, etc. of the LIDAR sensor. In some cases, LIDAR features may be normalized, for example, by subtracting a LIDAR mounting height from point cloud Z values, applying transforms based on the LIDAR tilt angle to normalize for orientation, dividing X, Y values by the LIDAR horizontal FOV to normalize for range, etc. As an example, normalization of LIDAR features (Xl) for orientation, mounting heights, and range where αl represents the LIDAR tilt angle, R(αl) represents a rotation matrix based on the tilt angle, hl represents the LIDAR mounting height, and FOVl represents a horizontal FOV of the LIDAR, can be expressed as

$$\frac{X {l}_{n o r m} = ( R ( α1 ) ⊙ ( Xl - h l ) )}{FOVl} ,$$

where ⊙ denotes element-wise operations. The normalized output Xlₙₒᵣₘ may be aligned to a common BEV coordinate system for BEV feature fusion.

In another example, configuration for a RADAR sensor may include calibration data such as a mounting height, tilt angle, range, etc. of the RADAR sensor. In some cases, RADAR features may be normalized, for example, by subtracting a RADAR mounting height from RADAR return elevations, apply rotation transforms based on RADAR tilt angle, dividing range values by a maximum range of the RADAR sensor to normalize for range, etc. As an example, normalization of RADAR features (Xr) for orientation, mounting position and range where αr represents the RADAR tilt angle, RMaxr represents maximum detection range, hr represents the RADAR mounting height, and R(αr) represents a rotation matrix based on the tilt angle can be expressed as

$$\frac{{Xr}_{n o r m} = ( R ( α r ) ⊙ ( Xr - hr ) )}{RMaxr} ,$$

where ⊙ denotes element-wise operations. The normalized output Xrₙₒᵣₘ may be aligned to a common BEV coordinate system for BEV feature fusion.

In some cases, adaptive normalization may be used by the feature normalization engine 604. Adaptive (e.g., dynamic) normalization may update (e.g., refine) normalization parameters dynamically, for example, based on sensor calibration and/or the environment. In some cases, a normalization parameter θ may be adaptive over time based on dynamic sensor calibration (e.g., where the camera or other sensor is calibrated over time so that the calibration information is refined over time) and/or environment estimates such that θₜ represents the normalization parameter at time t and Δ0ₜ represents an update to the normalization parameter for each timestep. For example, an environment estimate for a distance to an object may be used to dynamically adapt a camera FOV for normalization. For adaptive camera FOV normalization, the FOV parameter αfov can be updated as afovₜ₊₁=afovₜ+Δafovₜ. In some cases, Δafovₜ may be based on an estimated distance (dₜ) to an object such that Δafovₜ=γ*(dₜ−d̅), where γ represents a learning rate (e.g., how often the normalization parameter is adapted) and d represents an average distance of an object in focus or an object being detected. As objects get closer, the αfov can be increased (e.g., to “zoom in”) and αfov can be decreased as objects get further. A calibration loss [symbol] _{calib} may be used to provide a supervisory signal for Δθₜ such that [symbol] _{calib}=∥ƒ(xₜ; θₜ)−ƒ(xₜ; θₜ+Δθₜ)∥², where ƒ represents a normalization function, xₜ represents an input at time t, θₜ represents parameters at time t, Δθₜ represents a parameter update at timestep t, and ∥⋅∥² represents a squared L2 normalization. In some cases, minimizing [symbol] _{calib} trains a model adapting the normalizing parameters to satisfy calibration constraints. In some cases, online calibration procedures like target detection, sensor motion analysis etc. can refine Δθₜ for robust adaptation.

In some cases, the feature normalization engine 604 may be modularly designed with sub-modules for apply certain normalization transformations based on which sensor was used to obtain a particular feature and some operations may be performed for multiple types of sensors. In some cases, the modules may be chained together serially or in parallel.

In some cases, additional normalization techniques may be used. Examples of other normalization techniques may include learnable normalization, cross-modal calibration, domain randomization, etc. For learnable normalization, rather than using hand-designed transforms, a neural network or other machine learning model may be used to learn optimal normalization parameters (e.g., determine sensor/camera configuration information) from data in a sensor-agnostic way. An encoder-decoder network may be trained to transform raw sensor data into the normalized BEV space. In some cases, more complex sensor-specific distortions may be learned beyond simple transforms. For cross-modal calibration, complementary modalities may be used to co-calibrate each other. For example, LIDAR points (e.g., data obtained by a sensor, such as a LIDAR) may be used to fine-tune camera normalization parameters. This may enable online adaptation and allow for redundancy across sensors. For domain randomization, a normalization network may be trained using, for example, synthetic data augmentation and domain randomization of sensor parameters. In some cases, multiple normalization techniques may be used. For example, calibration-based normalization, as described above with respect to image, RADAR, and LIDAR sensors, may be used, followed by cross-modal calibration and domain randomization.

Returning to FIG. 6, the normalized BEV feature maps may be passed to a graph conversion engine 608. The normalized BEV feature maps may be invariant to sensor parameters and sensor agnostic. The graph conversion engine 608 may convert the normalized BEV feature maps to a graph-based representations such as BEV feature graphs 610A . . . 610T (collectively BEV features graphs 610). In some cases, the graph conversion engine 608 may receive normalized BEV feature maps at a certain step rate and may generate BEV features graphs 610A, 610B, through 610T based on the step rate.

In a graph-based representation, the graph represents relations (e.g., edges) as between a collection of entities (e.g., nodes). For example, feature points of the BEV feature map may be discretized into cells where each cell becomes a node of the graph and features may be aggregated from the feature points in the node. To discretize a normalized BEV feature map into cells, the normalized BEV feature map may be divided into cells, feature points within each cell may be aggregated using a function func( ) and the grid cells may be connected into a graph representation.

In some cases, a normalized BEV feature map from the feature normalization engine 604 may be divided into a grid where each grid cell corresponds to a node in the feature graph being generated and the feature corresponding to that node may be the aggregate of all the pointwise features within the grid cell (e.g., features within the cell). For example, for a normalized BEV feature map X of size W×H×C, the BEG feature map X may be discretized into a N×M grid where N=W/S and M=H/S, with stride S. For the N*M total grid cells, each grid cell may be represented as cᵢⱼ, where i goes from 1 to N and j goes from 1 to M. For each grid cell cᵢⱼ, let the set of k feature points falling within that grid cell cᵢⱼ be [p₀, p₁, . . . , pₖ], then each point p may have a feature vector associated with it such that pᵢ=[ƒ₁, ƒ₂, . . . , ƒ_{c}]. The feature points may be aggregated within a cell into a single feature vector for that cell node using a function func( ) such that x_{feat}(i, j)=func([p₀, p₁, . . . , pₖ]), to obtain a feature map x_{feat} of size N×M×C. In some cases, function func( ) may be a mean/average pooling function, max pooling function, a learned aggregator such as a transformer, or other aggregation function.

A graph G may then be constructed. The graph G may be expressed as G=(V, E), where nodes V=v₁, v₂, . . . , v_{NM} represent the N*M grid cells. The node features may then be the aggregated feature vectors such that vᵢ=x_{feat}(cellᵢ). Edges E may connect adjacent grid cells based on connectivity. In some cases, the graph-based representation for the BEV map may enable more efficient localization for matching sub-graphs against a global map graph.

In some cases, the BEV feature graphs 610 within a time window may be passed to a query graph engine 612. The query graph engine 612 may generate a query graph 614 by combining the BEV feature graphs 610 within the time window. For example, Gq=(Vq, Eq) may represent the query graph 614 that may be formed by combining the BEV feature graphs 610 {g1, g2, . . . gt} from time window t. Each node of the query graph 614 vi∈V_{q} has a feature vector xi. The query graph 614 may be passed to a query graph feature engine 616. The query graph feature engine 616 may generate a feature descriptor (e.g., meta-features) for the query graph. That is, the BEV feature graphs 610 may be a graph-based representation of features detected from sensor data, and the query graph feature engine 616 may identify and describe features (e.g., meta-features) of the graph-based representation of features in a query graph feature descriptor 618. In some cases, the query graph feature engine may be based on a graph neural network (GNN). In some cases, a GNN may perform message passing to update node features descriptors), which (e.g., may be expressed as zi=φ(xi, aggregate (xj: (vi, vj)∈Eq)), where φ is a neural network (e.g., GNN) that updates node features based on the nodes features and aggregated neighbor features. In some cases, the GNN may include multiple layers of message passing, which can be expressed as zi⁰=xi and zi¹=φ(zi^{(l-1)}, aggregate (zj^{(l-1)})), and where/indexes the layers.

In some cases, each layer further enriches node features by aggregating from a larger neighborhood. A final zi^{l} may provide a global context-aware representation for each node. In some cases, a multi-layer GNN may enable learning more discriminative features as compared to using the raw input features xi. In some cases, the query graph feature descriptor 618 may be passed to a query graph comparator engine 620.

The query graph comparator engine 620 may also receive a scene graph feature descriptor 622. The scene graph feature descriptor 622 may be generated based on a scene graph 624. The scene graph may be represented as Gs=(Vs, Es),

The scene graph 624 may be a map of features in an environment represented in graph form and the scene graph 624 may be built up over multiple observations of the features in the environment. For example, the query graph may describe features of a portion of an environment that is described by the scene graph 624. In some cases, the scene graph 624 may be built up using observations of features from multiple devices and may be remotely stored and accessed via a network connection (e.g., via a server). The scene graph 624 may be passed into a scene graph feature engine 626 that may identify and describe features (e.g., meta-features) of the graph to generate the scene graph feature descriptor 622. The scene graph feature engine 626 may be GNN based and may operate in a manner similar to the query graph feature engine 616. For example, Gs=(Vs, Es) may represent the scene graph 624. Each node of the scene graph 624 vj∈Vs has a feature vector xj. The scene graph 624 may be passed to a scene graph feature engine 626, which may perform message passing to update node features (e.g., descriptors), which may be expressed as zj=φ(xj, aggregate (xi: (vi, vj)∈Es)), where φ is a neural network (e.g., GNN). In some cases, the GNN may include multiple layers of message passing, which can e expressed as zi⁰=xi and zi¹=φ(zi^{(l-1)}, aggregate (zj^{(l-1)})), and where/indexes the layers.

The query graph comparator engine 620 may compare the query graph feature descriptor 618 to a scene graph feature descriptor 622 to locate a closest match 628 between the query graph and a portion of the scene graph to localize the features captured by the sensors within the environment by finding correspondences between nodes based on learned feature similarities. For example, the closest match between Gq and Gs may be expressed as ∀vᵢ∈V_{q}, match (vᵢ)=argmax_{∀v}_{ⱼ}_{∈v}_{ₛ}sim(zi, zj), where sim(zi, zj) may be a similarly function such as a cosine similarity. In some cases, match (vᵢ) may be a matched node in Gs for each node vᵢ in Gq. This may allow localizing Gq within Gs by finding correspondences between nodes based on learned feature similarities. The GNN may provide a learnable way to extract feature representations tailored for the matching. Based on the location of the features, a location within the environment of a device performing technique 600 may be determined.

In some cases, the scene graph 624 may be updated with information from the query graph 614. For example, the environment may have changed since the scene graph 624 was generated and the query graph 614 may include observations of such changes. These observations may be used to incrementally aggregate such new information into the scene graph 624. As an example, where scene graph Gs is updated using a localized query graph Gq, matched nodes (e.g., from the localization) may be expressed as (v₁q, v₁s), (v₂q, v₂s), . . . (vₖq, vₖs), where vₖq∈Gq and vₖs∈Gs are matched node pairs. To update Gs, for each matched pair (vₖq, vₖs), the features of the nodes may be aggregated such that zₖs=φ(xₖq, xₖs), where φ may be an aggregation function such as mean, max, min, etc. Once aggregated, the node vₖs may be updated with the aggregated features such that xₖs←zₖs. Edges connected to vₖs may be updated such that ∀vᵢm∈N(vₖs): eₖs, im←ψ(zₖs, xᵢm), where N(vₖs) may refer to the set of neighbor nodes that are connected eₖs, im←ψ(zₖs, xᵢm) to vₖs via edge eₖs, im, where vᵢm is a particular neighbor node of vₖs, where eₖs, im may be an edge connecting vₖs and vᵢm, where xᵢm is a feature vector of node vᵢm, where zₖs is an updated aggregated feature of vₖs, and where ψ is a function that takes node features zₖs and xᵢm as input and outputs an update edge feature eₖs, im. So for each neighbor vᵢm of vₖs, the edge eₖs, im may be updated using the new node features zₖs of vₖs and xᵢm of vᵢm. The aggregated information from vₖs may be propagated to a local neighborhood in the graph and this incrementally aggregates information from the current observation Gq into Gs through feature aggregation and edge updates. Over time, this allows the updated map of the environment in Gs to be built.

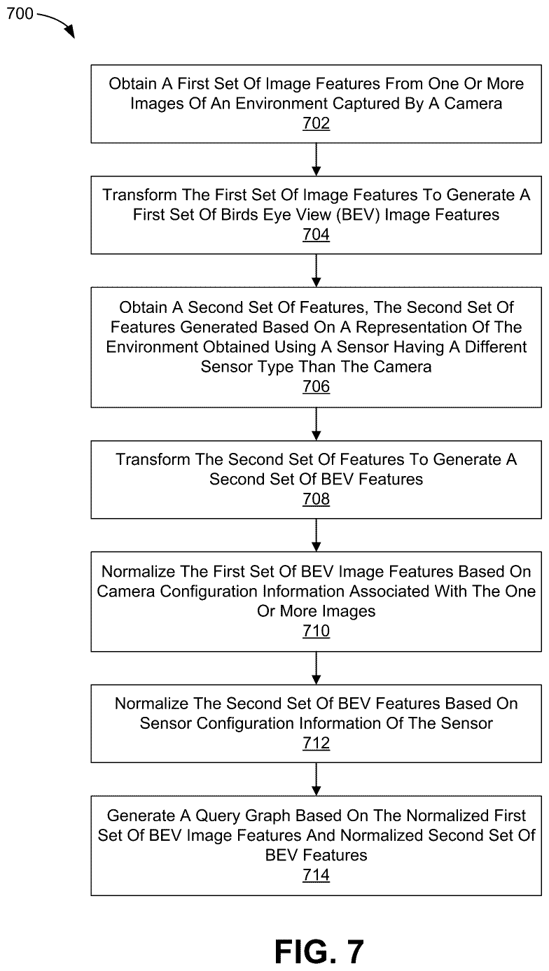

FIG. 7 is a flow diagram illustrating a process 700 for mapping, in accordance with aspects of the present disclosure. The process 700 may be performed by a computing device (or apparatus) or a component (e.g., a chipset, codec, etc.) of the computing device, such as image capturing and processing system 100 of FIG. 1, XR system 200 of FIG. 2, computing system 800 of FIG. 8, etc. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors (e.g., the image processor 150 of FIG. 1, the host processor 152 of FIG. 1, compute components 210 of FIG. 2, processor 810 of FIG. 8, and/or other processor(s)). In some cases, the operations of the process 700 can be implemented by a system having the architecture of computing system 800 of FIG. 8.

At block 702, the computing device (or component thereof) may obtain a first set of image features (e.g., intermediate camera features 506 of FIG. 5) from one or more images (e.g., input camera data 502 of FIG. 5) of an environment captured by a camera (e.g., image capture device 105A of FIG. 1, image sensor 202 of FIG. 2, image capturing device 330 of FIG. 3, input device 845 of FIG. 8, etc.). In some cases, the computing device (or component thereof) may include the camera and the sensor.

At block 704, the computing device (or component thereof) may transform (e.g., perspective transformation 508 of FIG. 5) the first set of image features to generate a first set of bird's eye view (BEV) image features.

At block 706, the computing device (or component thereof) may obtain a second set of features (e.g., intermediate LIDAR features 514 of FIG. 5, intermediate RADAR features 522 of FIG. 5, etc.,) the second set of features generated based on a representation of the environment obtained using a sensor having a different sensor type than the camera. In some cases, the sensor comprises one of a LIDAR sensor, a radar sensor, or a sonar sensor.

At block 708, the computing device (or component thereof) may transform (e.g., flattened 516 of FIG. 5, flattened 524 of FIG. 5, etc.) the second set of features to generate a second set of BEV features.

At block 710, the computing device (or component thereof) may normalize (e.g., by feature normalization engine 604 of FIG. 6) the first set of BEV image features based on camera configuration information associated with the one or more images. In some cases, the camera configuration information comprises calibration information for the camera, and wherein the sensor configuration information comprises calibration information for the sensor. In some examples, the calibration information for the camera includes information associated with at least one of a field of view (FOV) of the camera, principal point of the camera, and lens distortion information. As an example, camera features may be normalized, for example, by dividing pixel intensities by the camera FOV to normalize for field of view, subtracting principal point offset to normalize for camera position, applying an image undistortion transform to normalize for lens distortion, etc. In some cases, at least one of the calibration information for the camera or calibration information for the sensor is refined over time. In some examples, the computing device (or component thereof) may adapt the camera configuration information or sensor configuration information based on estimates of the environment.

At block 712, the computing device (or component thereof) may normalize the second set of BEV features based on sensor configuration information of the sensor. In some cases, the calibration information for the sensor includes information associated with at least one of a mounting height, tilt angle, FOV, and range of the sensor. As an example, configuration information for a LIDAR sensor may include calibration data (information) such as a mounting height, tilt angle, FOV, etc. of the LIDAR sensor. In some examples, at least one of the camera configuration information or sensor configuration information is determined by a machine learning model. In some cases, data obtained by the sensor is used by the machine learning model to determine the camera configuration information. In some examples, the normalized first set of BEV image features and the normalized second set of BEV features comprise a normalized BEV feature map, and wherein the at least one processor is configured to: divide the normalized BEV feature map into a grid of cells; and generate a BEV feature graph based on the divided normalized BEV feature map, wherein features of the normalized BEV feature map in a cell of the grid of cells are aggregated into a node of the BEV feature graph.

At block 714, the computing device (or component thereof) may generate a query graph (e.g., query graph 614 of FIG. 6) based on the normalized first set of BEV image features and the normalized second set of BEV features. In some cases, the computing device (or component thereof) may generate the query graph by aggregating the BEV feature graph with another BEV feature graph within a time window. In some examples, the computing device (or component thereof) may generate a query graph feature descriptor (e.g., query graph feature descriptor 618 of FIG. 6) based on features of the query graph. In some cases, the query graph feature descriptor is generated by a graph neural network. In some examples, the computing device (or component thereof) may compare the query graph feature descriptor to a scene graph feature descriptor (e.g., scene graph feature descriptor 622 of FIG. 6) to identify a portion of a scene graph (e.g., scene graph 624 of FIG. 6) that matches the query graph.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 700 and/or other processes described herein may include a processor, microprocessor, micro-computer, or other component of a device that is configured to carry out the steps of the process 700 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 700 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 700 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, camera, accelerometers, gyroscopes, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some examples, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the present disclosure include:

Aspect 1. A method for processing image data, comprising: obtaining a first set of image features from one or more images of an environment captured by a camera; transforming the first set of image features to generate a first set of bird's eye view (BEV) image features; obtaining a second set of features, the second set of features generated based on a representation of the environment obtained using a sensor having a different sensor type than the camera; transforming the second set of features to generate a second set of BEV features; normalizing the first set of BEV image features based on camera configuration information associated with the one or more images; normalizing the second set of BEV features based on sensor configuration information of the sensor; and generating a query graph based on the normalized first set of BEV image features and the normalized second set of BEV features.

Aspect 2. The method of Aspect 1, wherein the sensor comprises one of a light detection and ranging (LIDAR) sensor, a radar sensor, or a sonar sensor.

Aspect 3. The method of any of Aspects 1-2, wherein the camera configuration information comprises calibration information for the camera, and wherein the sensor configuration information comprises calibration information for the sensor.

Aspect 4. The method of Aspect 3, wherein the calibration information for the camera includes information associated with at least one of a field of view (FOV) of the camera, principal point of the camera, and lens distortion information.

Aspect 5. The method of any of Aspects 3-4, wherein the calibration information for the sensor includes information associated with at least one of a mounting height, tilt angle, FOV, and range of the sensor.

Aspect 6. The method of any of Aspects 3-5, wherein at least one of the calibration information for the camera or calibration information for the sensor is refined over time.

Aspect 7. The method of any of Aspects 3-6, further comprising adapting the camera configuration information or sensor configuration information based on estimates of the environment.

Aspect 8. The method of any of Aspects 1-7, wherein at least one of the camera configuration information or sensor configuration information is determined by a machine learning model.

Aspect 9. The method of Aspect 8, wherein data obtained by the sensor is used by the machine learning model to determine the camera configuration information.

Aspect 10. The method of any of Aspects 1-9, wherein the normalized first set of BEV image features and the normalized second set of BEV features comprise a normalized BEV feature map, and further comprising: dividing the normalized BEV feature map into a grid of cells; and generating a BEV feature graph based on the divided normalized BEV feature map, wherein features of the normalized BEV feature map in a cell of the grid of cells are aggregated into a node of the BEV feature graph.

Aspect 11. The method of Aspect 10, wherein generating the query graph comprises aggregating the BEV feature graph with another BEV feature graph within a time window.

Aspect 12. The method of Aspect 11, further comprising generating a query graph feature descriptor based on features of the query graph.

Aspect 13. The method of Aspect 12, wherein the query graph feature descriptor is generated by a graph neural network.

Aspect 14. The method of any of Aspects 12-13, further comprising comparing the query graph feature descriptor to a scene graph feature descriptor to identify a portion of a scene graph that matches the query graph.

Aspect 15. An apparatus for processing image data, the apparatus comprising: a sensor (or multiple sensors); at least one memory; and at least one processor coupled to the at least one memory, the at least one processor being configured to: obtain a first set of image features from one or more images of an environment captured by a camera; transform the first set of image features to generate a first set of bird's eye view (BEV) image features; obtain a second set of features, the second set of features generated based on a representation of the environment obtained using a sensor having a different sensor type than the camera; transform the second set of features to generate a second set of BEV features; normalize the first set of BEV image features based on camera configuration information associated with the one or more images; normalize the second set of BEV features based on sensor configuration information of the sensor; and generate a query graph based on the normalized first set of BEV image features and the normalized second set of BEV features.

Aspect 16. The apparatus of Aspect 15, wherein the sensor comprises one of a light detection and ranging (LIDAR) sensor, a radar sensor, or a sonar sensor.

Aspect 17. The apparatus of any of Aspects 15-16, wherein the camera configuration information comprises calibration information for the camera, and wherein the sensor configuration information comprises calibration information for the sensor.

Aspect 18. The apparatus of Aspect 17, wherein the calibration information for the camera includes information associated with at least one of a field of view (FOV) of the camera, principal point of the camera, and lens distortion information.

Aspect 19. The apparatus of any of Aspects 17-18, wherein the calibration information for the sensor includes information associated with at least one of a mounting height, tilt angle, FOV, and range of the sensor.

Aspect 20. The apparatus of any of Aspects 17-19, wherein at least one of the calibration information for the camera or calibration information for the sensor is refined over time.

Aspect 21. The apparatus of any of Aspects 17-20, wherein the at least one processor is configured to adapt the camera configuration information or sensor configuration information based on estimates of the environment.

Aspect 22. The apparatus of any of Aspects 15-21, wherein at least one of the camera configuration information or sensor configuration information is determined by a machine learning model.

Aspect 23. The apparatus of Aspect 22, wherein data obtained by the sensor is used by the machine learning model to determine the camera configuration information.

Aspect 24. The apparatus of any of Aspects 15-23, wherein the normalized first set of BEV image features and the normalized second set of BEV features comprise a normalized BEV feature map, and wherein the at least one processor is configured to: divide the normalized BEV feature map into a grid of cells; and generate a BEV feature graph based on the divided normalized BEV feature map, wherein features of the normalized BEV feature map in a cell of the grid of cells are aggregated into a node of the BEV feature graph.

Aspect 25. The apparatus of Aspect 24, wherein, to generate the query graph, the at least one processor is configured to aggregate the BEV feature graph with another BEV feature graph within a time window.

Aspect 26. The apparatus of Aspect 25, wherein the at least one processor is configured to generate a query graph feature descriptor based on features of the query graph.

Aspect 27. The apparatus of Aspect 26, wherein the query graph feature descriptor is generated by a graph neural network.

Aspect 28. The apparatus of any of Aspects 26-27, wherein the at least one processor is further configured to compare the query graph feature descriptor to a scene graph feature descriptor to identify a portion of a scene graph that matches the query graph.

Aspect 29. The apparatus of any of Aspects 15-28, wherein the apparatus further includes the camera and the sensor.

Aspect 30. A non-transitory computer-readable medium having stored thereon instructions that, when executed by at least one processor, cause the at least one processor to: obtain a first set of image features from one or more images of an environment captured by a camera; transform the first set of image features to generate a first set of bird's eye view (BEV) image features; obtain a second set of features, the second set of features generated based on a representation of the environment obtained using a sensor having a different sensor type than the camera; transform the second set of features to generate a second set of BEV features; normalize the first set of BEV image features based on camera configuration information associated with the one or more images; normalize the second set of BEV features based on sensor configuration information of the sensor; and generate a query graph based on the normalized first set of BEV image features and the normalized second set of BEV features.

Aspect 31. non-transitory computer-readable medium having stored thereon instructions that, when executed by at least one processor, cause the at least one processor to perform one or more operations according to any of Aspects 1-14

Aspect 32: An apparatus for image generation, comprising means for performing one or more of operations according to any of Aspects 1 to 14.

What is claimed is:

1. An apparatus for processing image data, the apparatus comprising:
a sensor;
at least one memory; and
at least one processor coupled to the at least one memory, the at least one processor being configured to:
obtain a first set of image features from one or more images of an environment captured by a camera;
transform the first set of image features to generate a first set of bird's eye view (BEV) image features;
obtain a second set of features, the second set of features generated based on a representation of the environment obtained using the sensor having a different sensor type than the camera;
transform the second set of features to generate a second set of BEV features;
normalize the first set of BEV image features based on camera configuration information associated with the one or more images;
normalize the second set of BEV features based on sensor configuration information of the sensor; and
generate a query graph based on the normalized first set of BEV image features and the normalized second set of BEV features.

2. The apparatus of claim 1, wherein the sensor comprises one of a light detection and ranging (LIDAR) sensor, a radar sensor, or a sonar sensor.

3. The apparatus of claim 1, wherein the camera configuration information comprises calibration information for the camera, and wherein the sensor configuration information comprises calibration information for the sensor.

4. The apparatus of claim 3, wherein the calibration information for the camera includes information associated with at least one of a field of view (FOV) of the camera, principal point of the camera, and lens distortion information.

5. The apparatus of claim 3, wherein the calibration information for the sensor includes information associated with at least one of a mounting height, tilt angle, FOV, and range of the sensor.

6. The apparatus of claim 3, wherein at least one of the calibration information for the camera or calibration information for the sensor is refined over time.

7. The apparatus of claim 3, wherein the at least one processor is configured to adapt the camera configuration information or sensor configuration information based on estimates of the environment.

8. The apparatus of claim 1, wherein at least one of the camera configuration information or sensor configuration information is determined by a machine learning model.

9. The apparatus of claim 8, wherein data obtained by the sensor is used by the machine learning model to determine the camera configuration information.

10. The apparatus of claim 1, wherein the normalized first set of BEV image features and the normalized second set of BEV features comprise a normalized BEV feature map, and wherein the at least one processor is configured to:
divide the normalized BEV feature map into a grid of cells; and
generate a BEV feature graph based on the divided normalized BEV feature map, wherein features of the normalized BEV feature map in a cell of the grid of cells are aggregated into a node of the BEV feature graph.

11. The apparatus of claim 10, wherein, to generate the query graph, the at least one processor is configured to aggregate the BEV feature graph with another BEV feature graph within a time window.

12. The apparatus of claim 11, wherein the at least one processor is configured to generate a query graph feature descriptor based on features of the query graph.

13. The apparatus of claim 12, wherein the query graph feature descriptor is generated by a graph neural network.

14. The apparatus of claim 12, wherein the at least one processor is configured to compare the query graph feature descriptor to a scene graph feature descriptor to identify a portion of a scene graph that matches the query graph.

15. The apparatus of claim 1, wherein the apparatus further includes the camera and the sensor.

16. A method for processing image data, comprising:
obtaining a first set of image features from one or more images of an environment captured by a camera;
transforming the first set of image features to generate a first set of bird's eye view (BEV) image features;
obtaining a second set of features, the second set of features generated based on a representation of the environment obtained using a sensor having a different sensor type than the camera;
transforming the second set of features to generate a second set of BEV features;
normalizing the first set of BEV image features based on camera configuration information associated with the one or more images;
normalizing the second set of BEV features based on sensor configuration information of the sensor; and
generating a query graph based on the normalized first set of BEV image features and the normalized second set of BEV features.

17. The method of claim 16, wherein the sensor comprises one of a light detection and ranging (LIDAR) sensor, a radar sensor, or a sonar sensor.

18. The method of claim 16, wherein:
the camera configuration information comprises calibration information for the camera, the calibration information for the camera including information associated with at least one of a field of view (FOV) of the camera, principal point of the camera, and lens distortion information; and
the sensor configuration information comprises calibration information for the sensor, the calibration information for the sensor including information associated with at least one of a mounting height, tilt angle, FOV, and range of the sensor.

19. The method of claim 16, wherein the normalized first set of BEV image features and the normalized second set of BEV features comprise a normalized BEV feature map, and further comprising:
dividing the normalized BEV feature map into a grid of cells; and
generating a BEV feature graph based on the divided normalized BEV feature map, wherein features of the normalized BEV feature map in a cell of the grid of cells are aggregated into a node of the BEV feature graph.

20. The method of claim 19, wherein generating the query graph comprises aggregating the BEV feature graph with another BEV feature graph within a time window.
